(19) United States
(12) Patent Application Publication
(10) Pub. No.: US 2003/0118777 A1
(43) Pub. Date: Jun. 26, 2003

(54) Imaged nonwoven fabrics in hygienic wipe applications

(75) Inventors: Kou-Shu Edward Chang, Charlotte, NC (US); Douglas Stowers, Charlotte, NC (US)

Correspondence Address: WOOD, PHILLIPS, KATZ, CLARK & MORTIMER, 500 W. MADISON STREET, SUITE 3800, CHICAGO, IL, 60661, US

(73) Assignee: Polymer Group, Inc.

(21) Appl. No.: 10/315,309

(22) Filed: Dec. 10, 2002

Related U.S. Application Data
(60) Provisional application No. 60/339,931, filed on Dec. 10, 2001.

(51) Int. Cl. B32B 3/00

(52) U.S. Cl. 428/156

(57) ABSTRACT

The present invention is directed a nonwoven fabric which is imparted with a durable three-dimensional image or pattern during the fabrication stage. The three-dimensional image or pattern imparted into the structure of the nonwoven fabric results in a lofty material with capturing recesses or “pockets” which act to entrap and retain body surface contaminants. The three-dimensional image or pattern also results in a number of fibrous ends and loops which extend beyond the surface of the recesses or “pockets”, which in turn, improve the nonwoven fabrics ability to effectively collect low viscosity contaminants from the surface of the skin to be cleaned.

### TECHNICAL FIELD

The present invention relates generally to a nonwoven fabric, and specifically to a nonwoven fabric imparted with a three-dimensional pattern, which results in a material imminently suitable for application in the cleaning and cleansing of skin surfaces.

### BACKGROUND OF THE INVENTION

The general use of nonwoven fabrics as a component in cleaning and/or cleansing articles is well known in the art. Various cleaning products, and specifically personal or baby wipes, are commercially available which utilize one or more layers of nonwoven fabrics in the construction of said wipe. Primarily, these conventional wipes have been two-dimensional or planar in construction. As the surface topography of such two-dimensional wipes is inherently restricted by the composition of the wipe, frictional cleaning induced by the composition is limited, thus necessitating increased consumption of said wipe to effect satisfactory levels of cleanliness.

Attempts have been made to induce three-dimensionality into the conventional wipe in order to improve cleaning performance. Prior art materials, such as certain high-end consumer baby wipes, have incorporated an elastic film to induce crenulation of the resultant wipe surface. While this practice induces three-dimensionality to the wipe, the effect is transitory and can be easily removed when the wipe is distended during use.

Similarly, cleaning wipes have also been fabricated by various embossing processes. Again, these processes impart a three-dimensionality that can be reduced, if not removed, from the surface topography of the wipe when subjected to distention and pressure forces encountered during use.

A need exists for a nonwoven fabric cleaning and/or cleansing product, which exhibit durable three-dimensionality under conventional wiping conditions.

### SUMMARY OF THE INVENTION

The present invention is directed a nonwoven fabric which is imparted with a durable three-dimensional image or pattern during the fabrication stage. The three-dimensional image or pattern imparted into the structure of the nonwoven fabric results in a lofty material with capturing recesses or “pockets” which act to entrap and retain body surface contaminants. The three-dimensional image or pattern also results in a number of fibrous ends and loops which extend beyond the surface of the recesses or “pockets”, which in turn, improve the nonwoven fabrics ability to effectively collect low viscosity contaminants from the surface of the skin to be cleaned. Further, the recesses and the extended fibrous surface act in conjunction to effectively remove skin contaminants, such as dirt or variable-viscosity human exudates, from the skin surface without the need for repeated wiping, and the irritation caused thereby.

In accordance with the present invention, a method of making the nonwoven fabric embodying the present invention includes the steps of providing a precursor web comprising a fibrous matrix, said fibrous matrix including finite staple length fibers, continuous filaments, and the blends thereof. In a particularly preferred form, the fibrous matrix is composed of a blend of staple fibers, which are carded and cross-lapped to form a precursor web. It is also preferred that the precursor web be subjected to pre-entangling on a foraminous forming surface prior to imaging and patterning.

A method of making the present durable nonwoven fabric comprises the steps of providing a precursor web, which is subjected to hydroentangling. A polyester/rayon fiber blend can be used to desirably yield a nonwoven fabric suitable for subsequent use, or treatment with, liquid cleaning agents and lotions. The precursor web is formed into an imaged and patterned nonwoven fabric by hydroentanglement on a three-dimensional image transfer device. The image transfer device defines three-dimensional elements against which the precursor web is forced during hydroentangling, whereby the fibrous constituents of the web are imaged and patterned by movement into regions between the three-dimensional elements of the transfer device.

In the preferred form, the precursor web is hydroentangled on a foraminous surface prior to hydroentangling on the image transfer device. This pre-entangling of the precursor web acts to integrate the fibrous components of the web, but does not impart imaging and patterning as can be achieved through the use of the three-dimensional image transfer device.

Other features and advantages of the present invention will become readily apparent from the following detailed description, the accompanying drawings, and the appended claims.

### BRIEF DESCRIPTION OF THE DRAWINGS

FIG. 1 is a diagrammatic view of an apparatus for manufacturing a nonwoven fabric, embodying the principles of the present invention;

FIG. 2 is a plan view of a three-dimensional nonwoven fabric, made in accordance with the present invention. The magnification level is about 12×;

FIG. 3 is a plan view of a three-dimensional nonwoven fabric, made in accordance with the present invention. The magnification level is about 12×;

FIGS. 4-7 are plan views of three-dimensional image transfer devices of the types used for practicing the present invention, referred to as being of the “nub” type; and

FIGS. 8-10 are plan views of three-dimensional image transfer devices of the types used for practicing the present invention, referred to herein as “geodesic” types.

### DETAILED DESCRIPTION

While the present invention is susceptible of embodiment in various forms, there is shown in the drawings and will hereinafter be described a presently preferred embodiment of the invention, with the understanding that the present disclosure is to be considered as an exemplification of the invention, and is not intended to limit the invention to the specific embodiment illustrated.

The present invention is directed a nonwoven fabric which is imparted with a durable three-dimensional image or pattern during the fabrication stage. The three-dimensional image or pattern imparted into the structure of the nonwoven fabric results in two pronounced effects. First, a lofty material is formed with skin-contaminate capturing recesses or “pockets” which act to entrap and entrain dirt and/or cellular debris. Second, the three-dimensional image or pattern results in a number of fibrous ends and loops which extend beyond the surface of the recesses or “pockets”, which in turn, improve the nonwoven fabrics ability to effectively collect contaminants from the skin surface.

Further, the recesses and the extended fibrous surface act in conjunction to effectively remove skin contaminants, such as variable-viscosity human exudates, from the skin surface without the need for repeated wiping.

The three-dimensional nonwoven fabric is typically used as a hand-applied wipe, in either a discontinuous sheet form or in a perforated continuous roll form. The wipe may either be dry, or used in conjunction with a cleaning agent or lotion.

For application in cleaning products, a nonwoven fabric must exhibit a combination of specific physical characteristics. For example, the nonwoven fabrics used in cleansing of the face should be soft and drapeable so as to conform to the contours of the face and yet withstand brisk agitation inherent to facial cleansing procedures. Further, nonwoven fabrics used in cleaning applications must be resistant to abrasion and linting yet also exhibit sufficient strength and tear resistance.

Nonwoven fabrics are used in a wide variety of applications where the engineered qualities of the fabric can be advantageously employed. These types of fabrics differ from traditional woven or knitted fabrics in that the fabrics are produced directly from a fibrous mat, eliminating the traditional textile manufacturing processes of multi-step yarn preparation, and weaving or knitting. Entanglement of the fibers or filaments of the fabric acts to provide the fabric with a useful level of integrity. Subsequent to entanglement, fabric integrity can be further enhanced by the application of binder compositions and/or by thermal stabilization of the entangled fibrous matrix.

U.S. Pat. No. 3,485,706, to Evans, hereby incorporated by reference, discloses processes for effecting hydroentanglement of nonwoven fabrics. More recently, hydroentanglement techniques have been developed which impart images or patterns to the entangled fabric by effecting hydroentanglement on three-dimensional image transfer devices. Such three-dimensional image transfer devices are disclosed in U.S. Pat. No. 5,098,764, hereby incorporated by reference, with the use of such image transfer devices being desirable for providing a fabric with enhanced physical properties as well as having a pleasing appearance.

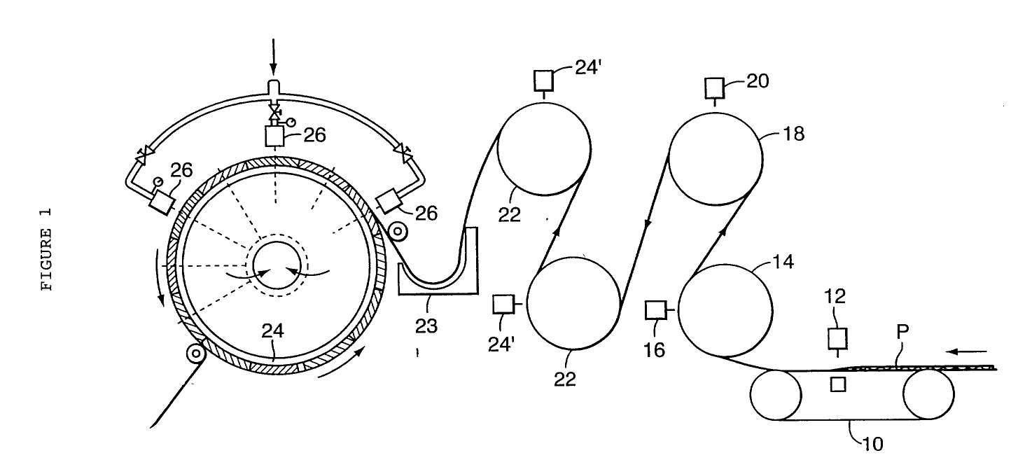

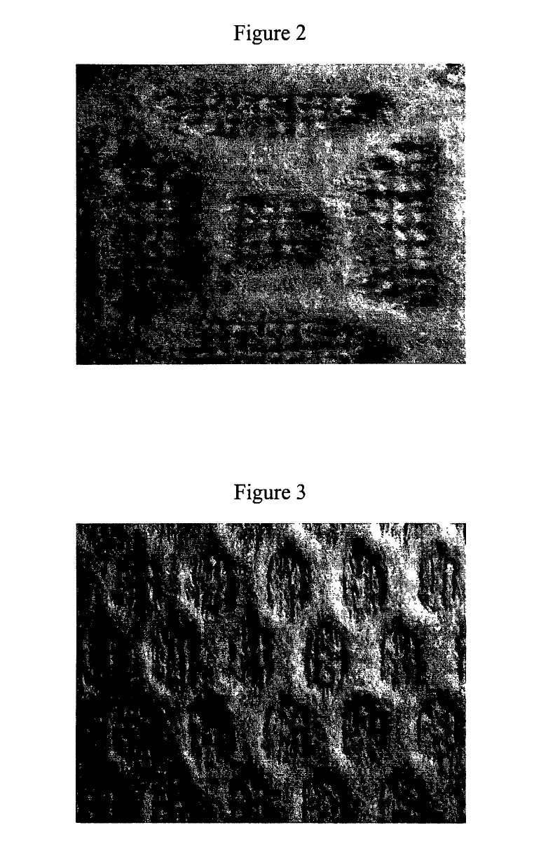

With reference to FIG. 1, therein is illustrated an apparatus for practicing the present method for forming a nonwoven fabric. The fabric is formed from a fibrous matrix preferably comprising staple length fibers, but it is within the purview of the present invention that different types of fibers, or fiber blends, and with inclusive of an optional scrim layer, can be employed. The fibrous matrix is preferably carded and air-laid or cross-lapped to form a precursor web, designated P.

Manufacture of a nonwoven fabric embodying the principles of the present invention is initiated by providing the precursor nonwoven web formed from a fibrous matrix. The fibrous matrix can be comprised of fibers or filaments selected from natural or synthetic composition, of homogeneous or mixed fiber length. Suitable natural fibers include, but are not limited to, cotton, wood pulp and viscose rayon. Synthetic fibers, which may be blended in whole or part, include thermoplastic and thermoset polymers. Thermoplastic polymers suitable for blending include polyolefins, polyamides and polyesters. The thermoplastic polymers may be further selected from homopolymers; copolymers, conjugates and other derivatives including those thermoplastic polymers having incorporated melt additives or surface-active agents, and splittable constructions. The profile of the fiber or filament is not a limitation to the applicability of the present invention. When a finite staple length fiber is used, staple lengths are selected in the range of 0.25 inch to 8 inches, the range of 1 to 2 inches being preferred and the fiber denier selected in the range of 1 to 15, the range of 2 to 6 denier being preferred for general applications. The profile of the fiber is not a limitation to the applicability of the present invention.

The composition of the three-dimensional imaged nonwoven fabric can be specifically chosen in light of the cleaning agent to be impregnated therein or applied thereon. For example, if a water based surfactant compound is to be applied, a hydrophilic naturally derived fiber such as rayon or a hydrophilic melt additive in a polyester staple fiber would facilitate in the imaged nonwoven fabric absorbing a controlled amount of a surfactant compound. Should it be known that an abrasive cleaning surface facing material is desirable, a polypropylene staple fiber selected from the upper denier range of staple fibers would be advised.

It is within the purview of the present invention that a scrim can be interposed in the formation of the precursor nonwoven web. The purpose of the scrim is to reduce the extensibility of the resultant three-dimensional imaged nonwoven fabric, thus reducing the possibility of three-dimensional image distortion and further enhancing fabric durability. Suitable scrims include unidirectional monofilament, bi-directional monofilament, expanded films, and thermoplastic spunbond.

It is also within the purview of the present invention that a binder material can be either incorporated as a fusible fiber in the formation of the precursor nonwoven web or as a liquid fiber adhesive applied after imaged fabric formation. The binder material will further improve the durability or otherwise provide enhanced cleaning performance of the resultant imaged nonwoven fabric during use.

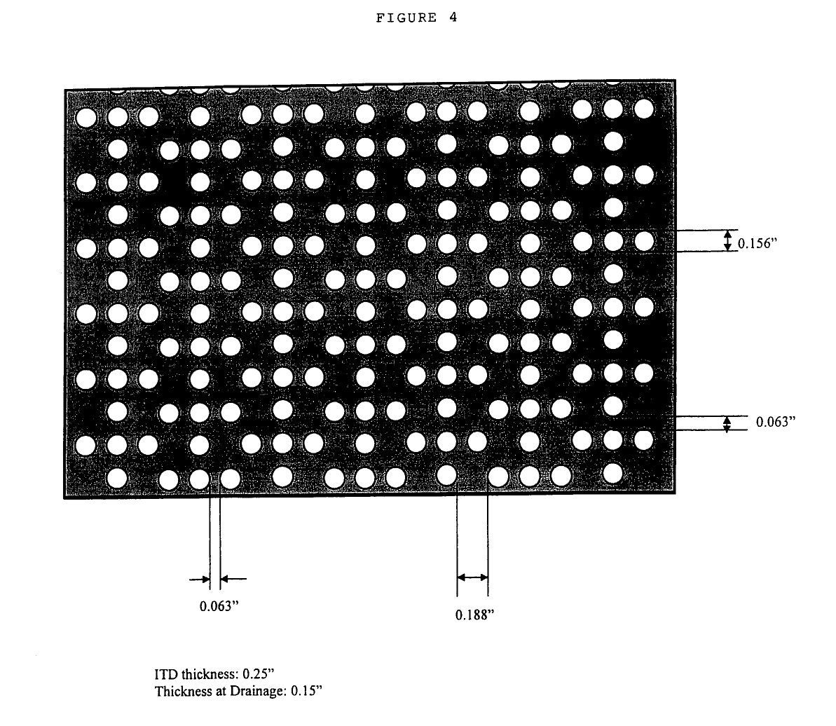

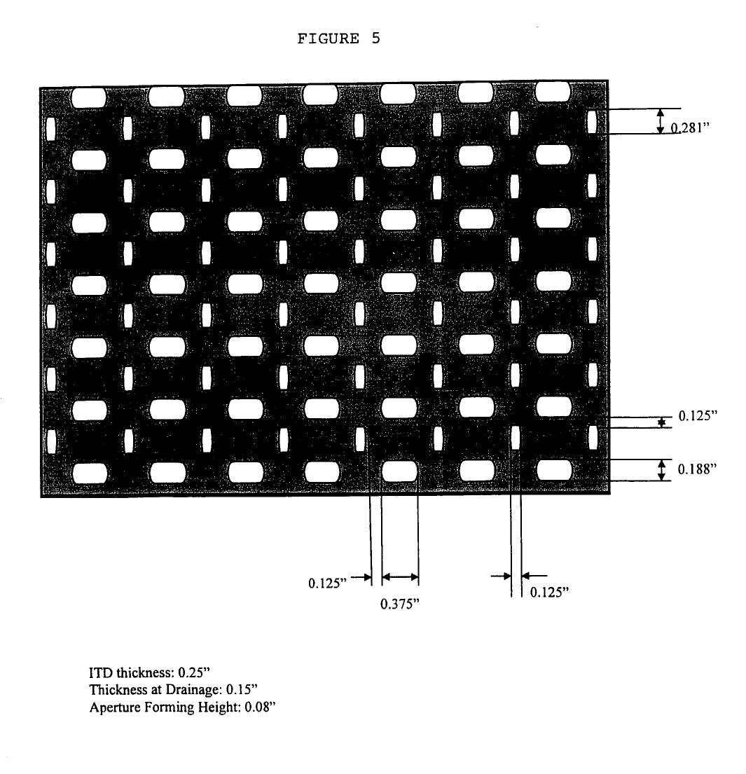

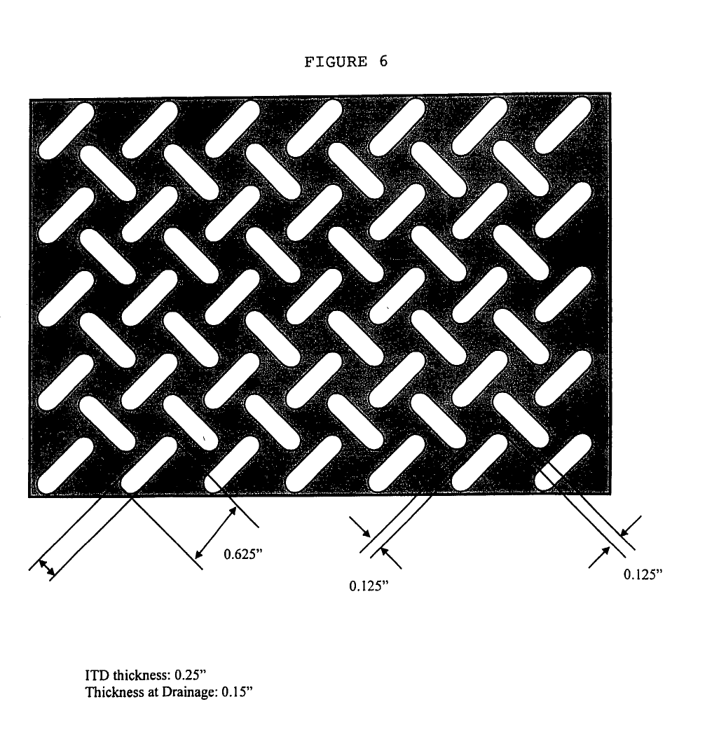

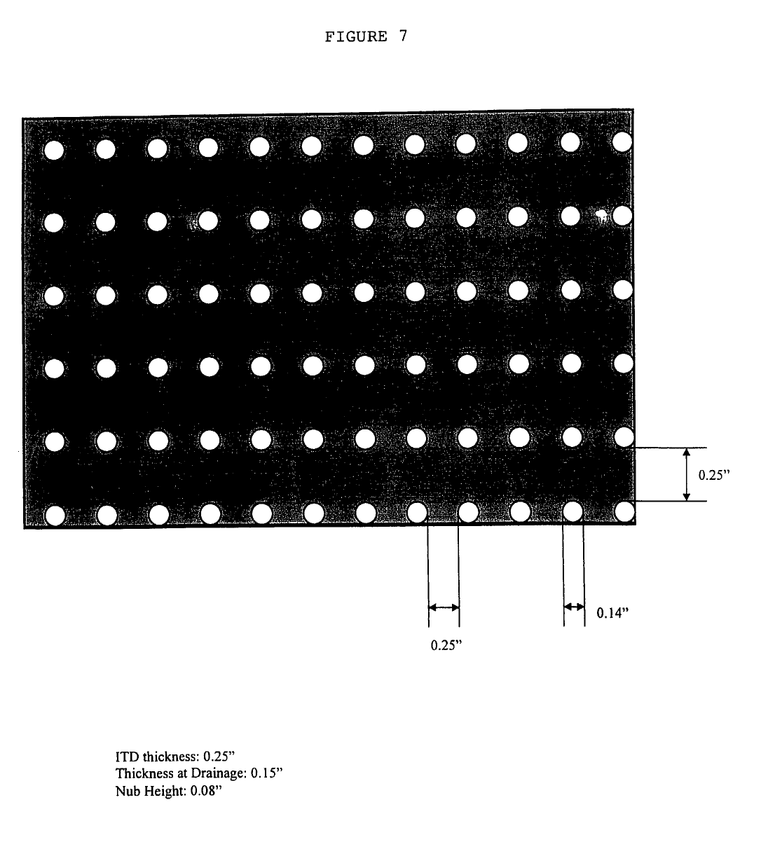

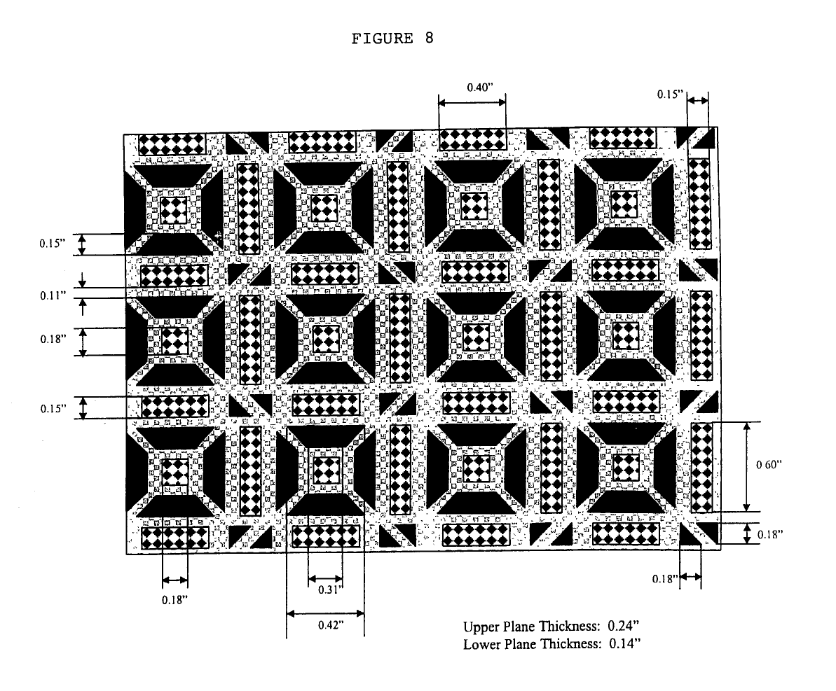

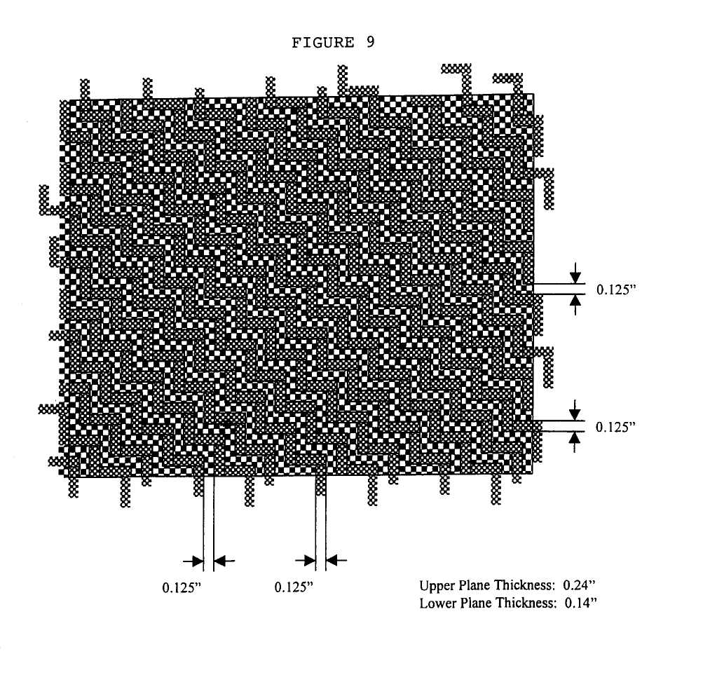

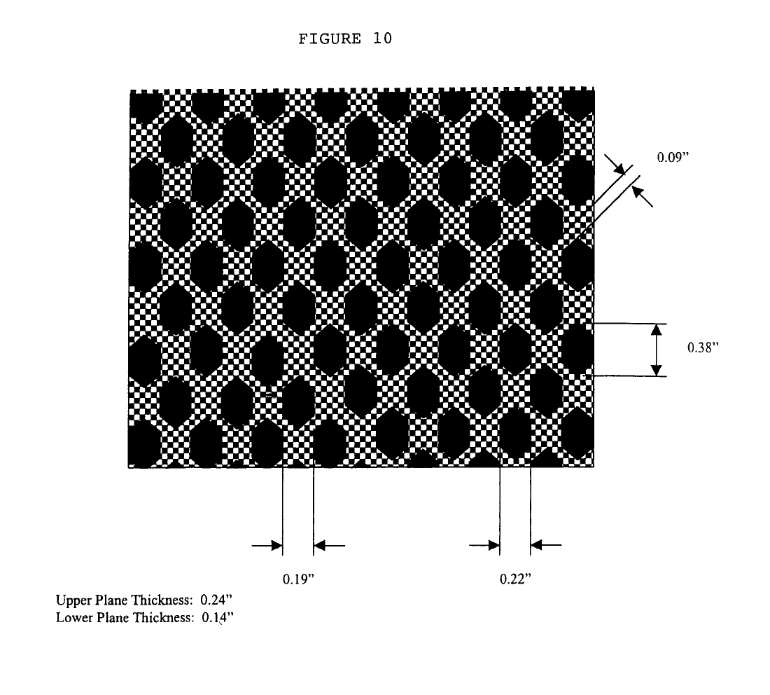

FIG. 1 depicts the means for imparting the three-dimensional quality during the manufacture of the nonwoven fabric. The image transfer device shown as imaging drum 18 can be selected from a broad variety of three-dimensional image types. Exemplary FIGS. 4, 5, 6, and 7, are three-dimensional images of the “nub” type. Fibrous nubs are formed during the process of entangling on the imaging drum 18, these nubs extending out of the planar background of the resulting fabric. These fibrous nubs act as the high points and resulting surface contact. FIGS. 8, 9, and 10 are examples of the “geodesic” type of images. In this image type, regular blocks of entangled constituent fibers extended out of the planar background, the fibrous blocks creating high points that are particular effective at providing air passageways parallel to the substrate surface. Due to the flexibility inherent to the fabrication of the image on the image transfer device, variations in three-dimensional image including multi-planar images, variations in image juxtaposition, and the ability to create complex images having no discontinuities allow for the creation of profiles in nonwoven fabrics heretofore impossible.

### EXAMPLES

Using a forming apparatus as illustrated in FIG. 1, a nonwoven fabric was made in accordance with the present invention by providing a precursor web comprising 70 weight percent polyester staple fibers and 30 weight percent rayon staple fibers. The web had a basis weight of 69 grams per square yard (plus or minus 7%).

The fabric comprised polyester (1.5 denier) and rayon (1.6 denier). Prior to patterning and imaging of the precursor web, the web was entangled by a series of entangling manifolds such as diagrammatically illustrated in FIG. 1. FIG. 1 illustrates disposition of precursor web P on a foraminous forming surface in the form of belt 10, with the web acted upon by an entangling manifold 12. The web then passes sequentially over a drum 14 having a foraminous forming surface, for entangling by entangling manifold 16, with the web thereafter directed about the foraminous forming surface of a drum 18 for entangling by entanglement manifold 20. The web is thereafter passed over successive foraminous drums 22, with successive entangling treatment by entangling manifolds 24, 24′. In the present examples, each of the entangling manifolds included 120 micron orifices spaced at 42.3 per inch, with the manifolds operated successively at 30, 10, 30, 10, and 10 bar, with a line speed of about 40 yards per minute. A web having a width of 84 inches was employed.

The entangling apparatus of FIG. 1 further includes an imaging and patterning drum 24 comprising a three-dimensional image transfer device for effecting imaging and patterning of the now-entangled precursor web. The entangling apparatus includes a plurality of entangling manifolds 26, which act in cooperation with the three-dimensional image transfer device of drum 24 to effect patterning of the fabric. In the present example, the entangling manifolds 26 were successively operated at 90, 95, and 100 bar, at a line speed which was the same as that used during pre-entanglement.

From the foregoing, it will be observed that numerous modifications and variations can be affected without departing from the true spirit and scope of the novel concept of the present invention. It is to be understood that no limitation with respect to the specific embodiments illustrated herein is intended or should be inferred. The disclosure is intended to cover, by the appended claims, all such modifications as fall within the scope of the claims.

What is claimed is:

1. A hygienic cleaning wipe, comprising;
a pre-bond fibrous matrix of staple length fibers,
a three-dimensional transfer device,
hydroentangling the pre-bond fibrous matrix on the three-dimensional transfer device so as to impart a three-dimensional pattern into the resultant nonwoven fabric, and
the three-dimensional nonwoven fabric exhibiting the ability to entrap and retain contaminates from a skin surface.

2. A hygienic cleaning wipe as in claim 1, wherein said contaminates are variable-viscosity human exudates.

3. A hygienic cleaning wipe, comprising;
a pre-bond fibrous matrix of staple length fibers comprised of an interposed scrim layer, said pre-bond fibrous matrix being hydroentangled on a three-dimensional transfer device so as to impart a three-dimensional pattern into the resultant nonwoven fabric, and
the three-dimensional nonwoven fabric exhibiting the ability to entrap and retain contaminates from a skin surface.

4. A hygienic cleaning wipe as in claim 2, wherein said scrim layer is selected from the group consisting of unidirectional monofilaments, bi-directional monofilaments, expanded films, and thermoplastic spunbond.
